(19) United States
(12) Patent Application Publication
(10) Pub. No.: US 2007/0111751 A1
(43) Pub. Date: May 17, 2007

(54) COMMUNICATION TERMINAL APPARATUS

(75) Inventor: Eiji IIMORI, Hino-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/623,465

(22) Filed: Jan. 16, 2007

Related U.S. Application Data
(62) Division of application No. 10/793,262, filed on Mar. 4, 2004.

(30) Foreign Application Priority Data
Jul. 16, 2003 (JP) 2003-197856

(51) Int. Cl. H04Q 7/20

(52) U.S. Cl. 455/550.1; 455/458; 455/434

(57) ABSTRACT

In the present invention, an alternate base station is switched to a serving base station if second information received by receiving means under control of first control means corresponds to second information stored in storing means. The receiving means is controlled to receive first information from the serving bas station if communication with the serving base station needs to be made. Storing of the first information is controlled while making the first information correspond to identification information of the serving base station.

### CROSS-REFERENCE TO RELATED APPLICATIONS

The present application is a Divisional Application of U.S. application Ser. No. 10/793,262, filed Mar. 4, 2004, which is based upon and claims the benefit of priority from prior Japanese Patent Application No. 2003-197856, filed Jul. 16, 2003, the entire contents of which are incorporated herein by reference.

### BACKGROUND OF THE INVENTION

1. Field of the Invention

This invention relates to a communication terminal apparatus in a radio communication system such as a mobile telephone system.

2. Description of the Related Art

In a wideband code division multiple access (W-CDMA) system which is one of mobile telephone systems, generation of an incoming call is monitored in the intermittent reception scheme.

At the monitoring time, the intermittent reception scheme operates the communication function during a period when a paging signal notify presence or absence of an incoming call is transmitted intermittently from a base station (ready state), and operates an operating section, a display section and their related portions during other periods (sleep state).

If an incoming call is detected from the paging signal in the ready state, the intermittent reception is stopped, the communication function is continuously operated to make communication. If the incoming call is not detected, a timer is reset, a power supply of each section is turned off, and the sleep state is maintained again until the paging signal is transmitted.

Thus, the consumed power can be reduced at the incoming call standby time by employing the intermittent reception scheme.

Incidentally, when the ready state is set again from the sleep state, synchronization is to be made with a base station which has received signals in the previous ready state. However, if the receiving level from the base station is low, cell search or what is called reselection is executed to search for the other base station suitable for the communication.

For example, in the W-CDMA system based on the 3rd Generation Partnership Project (3GPP), inherent system information transmitted over a BCCH (referred to hereinafter as BCCH) notified from a newly detected base station is acquired when the reselection is executed. After that, intermittent reception is executed on the basis of the BCCH.

However, the BCCH provides the newly detected base station with a large amount of information and the reception of the information requires a receiving speed of about 1000 to 2000 milliseconds. For this reason, much power is consumed for the reception of the BCCH. If the reselection is frequently executed, battery power may be wasted.

### BRIEF SUMMARY OF THE INVENTION

The present invention has been accomplished to solve the above-described problem. The object of the present invention is to provide a communication terminal apparatus capable of reducing power consumption during intermittent reception.

According to an aspect of the present invention, there is provided a communication terminal apparatus for making communication with a base station connectable with a communication network. The apparatus comprises receiving means for receiving a signal transmitted from the base station, storing means for storing first information and second information which are received from the base station by the receiving means, while making the first information and second information correspond to identification information of the base station, first control means for controlling the receiving means in accordance with the first information to receive a signal transmitted from a serving base station configured to transmit a paging signal to the apparatus, if a preset time has passed, level detecting means for detecting a level of the signal received by the receiving means under control of the first control means, second control means for controlling the receiving means to stop the operation of the receiving means if the level detected by the level detecting means is equal to or higher than a threshold value, base station detecting means for detecting an alternate base station suitable for the reception other than the serving base station by controlling the receiving means if the level detected by the level detecting means is lower than a threshold value, third control means for controlling the receiving means to receive second information from the alternate base station if information received from the alternate base station stored in the storing means, fourth control means for controlling the receiving means to receive the first information from the alternate base station if the second information received by the receiving means under control of the third control means does not correspond to the second information stored in the storing means, first storing controlling means for controlling storing of the first information received by the receiving means under control of the fourth control means, in the storing means, while making the first information correspond to identification information of the alternate base station, base station switching means for switching the alternate base station to the serving base station if the second information received by the receiving means under control of the third control means corresponds to the second information stored in the storing information, fifth control means for controlling the receiving means to receive the first information from the serving base station if there is a necessity to make communication with the serving base station, and second storing controlling means for controlling storing of the first information received by the receiving means under control of the fifth control means, in the storing means, while making the first information correspond to identification information of the serving base station.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram of a communication terminal apparatus according to an embodiment of the present invention;

FIG. 2 is a flowchart of operations at intermittent reception in the communication terminal apparatus shown in FIG. 1;

FIG. 3 is a flowchart of reselection in the intermittent reception shown in FIG. 2;

FIG. 4 is a flowchart of communication control in the intermittent reception shown in FIG. 2;

FIG. 5 is an illustration of executing the intermittent reception by the communication terminal apparatus shown in FIG. 1 while moving;

FIG. 6 is an illustration of executing the intermittent reception by the communication terminal apparatus shown in FIG. 1 while moving;

FIG. 7 is an illustration of executing the intermittent reception by the communication terminal apparatus shown in FIG. 1 while moving;

FIG. 8 is a block diagram of a communication terminal apparatus according to an embodiment of the present invention;

FIG. 9 is a flowchart showing an operation of a discontinuous reception processing unit according to the present invention; and

FIG. 10 is a chart of a system information table according to the present invention.

### DETAILED DESCRIPTION OF THE INVENTION

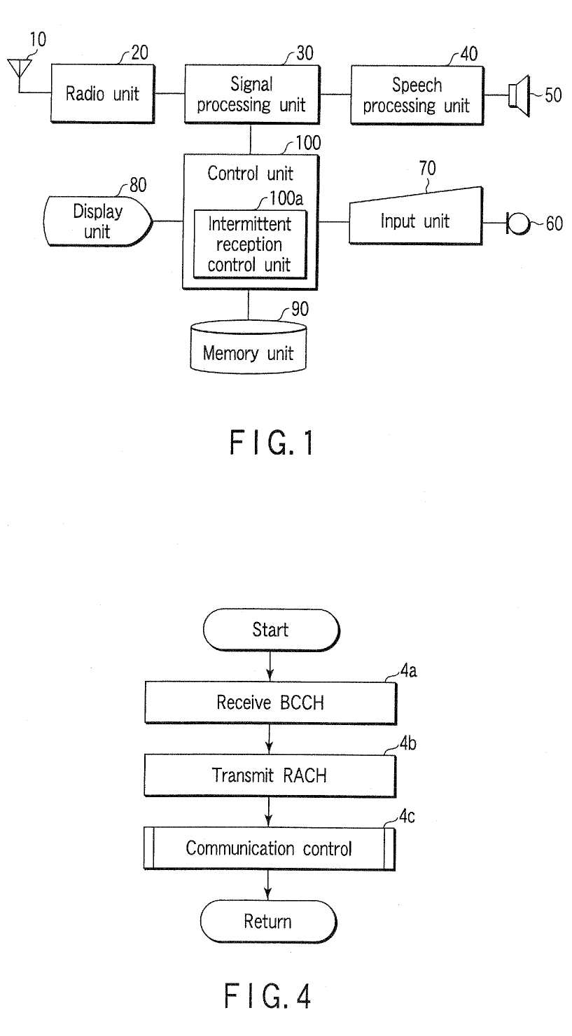

FIG. 1 is a block diagram of a communication terminal apparatus according to an embodiment of the present invention. A W-CDMA mobile communication terminal is explained in the following descriptions.

A radio unit 20 makes radio communication in the W-CDMA scheme with a base station (not shown) via an antenna 10. The radio unit 20 down-converts a radio signal received from the base station to obtain a spread baseband signal.

A signal processing unit 30 despreads the baseband signal to obtain information indispensable for the communication with the base station and data to be transmitted to the mobile communication terminal. The signal processing unit 30 also has a function of detecting a receiving signal level for each base station on the basis of the baseband signal and notifies the detected level to a control unit 100.

A speech processing unit 40 decodes the data obtained by the signal processing unit 30 to reproduce a speech signal. The speech signal is output from a speaker 50. The speech processing unit 40 also encodes speech input from a microphone 60 as speech data, which is output to the signal processing unit 30.

The signal processing unit 30 executes a spreading operation by using the speech data to generate a modulation signal. The radio unit 20 up-converts the modulation signal into a radio signal, which is transmitted to the base station via the antenna 10.

An input unit 70 is composed of a plurality of keys and accepts various instructions from a user. The accepted information is output to the control unit 100. A display unit 80 is a liquid crystal display (LCD) or the like which visually display the information. The display unit 80 is controlled by the control unit 100.

A memory unit 90 is a unit using a semiconductor such as a RAM or ROM. The memory unit 90 stores the control program and control data of the control unit 100, and user data such as telephone directory data and mail data.

The memory unit 90 has a cache area in which system information (BCCH) received from the base station is stored in association with identification information of the base station and the receiving level. The information about number m of base stations is also stored in the cache area.

The control unit 100 configured to wholly control the units of the mobile communication terminal controls the radio unit 20 and the signal processing unit 30 to implement the W-CDMA radio communication. In addition, the control unit 100 controls incoming and outgoing calls in accordance with the instructions from the input unit 70, and controls the display unit 80 to display generation of incoming and outgoing calls, conditions of the mobile communication terminal, information stored in the memory unit 90 and the like.

The control unit 100 comprises an intermittent reception control unit 100a. The control unit 100a controls the radio unit 20, the signal processing unit 30 and the like to make them execute intermittent operations at the standby time. Power consumption of a battery (not shown) can be thereby reduced.

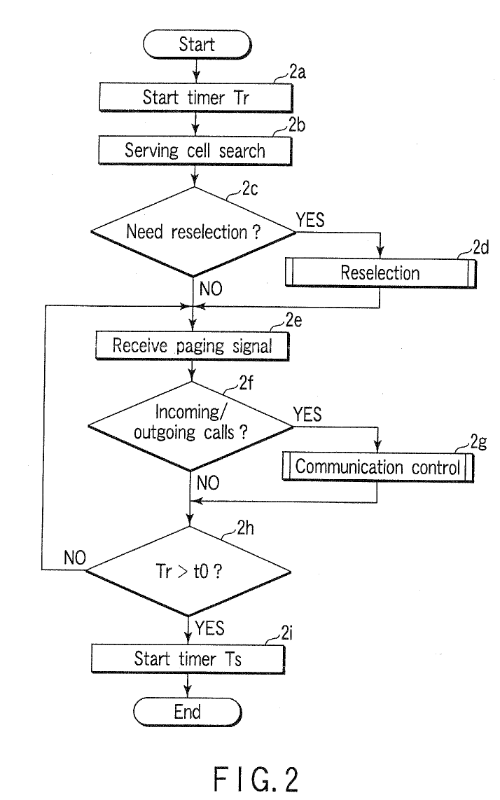

Next, operations of the mobile communication terminal having the above-described structure will be explained. FIGS. 2 to 4 are flowcharts of the operations of the mobile communication terminal, which are controlled by the control unit 100a. The processing of FIG. 2 is started when a sleep state of the mobile communication terminal is switched to a ready state.

First, in step 2a, the control unit 100a starts a timer Tr. The operation proceeds to step 2b.

In step 2b, the control unit 100a starts the radio unit 20 and the signal processing unit 30 to execute the serving cell search and receive a radio signal from a base station in a serving cell (hereinafter referred to as a serving base station). The operation proceeds to step 2c. The serving cell indicates a cell including the base station which has made communication in the previous ready state.

In step 2c, the control unit 100a compares a level of the signal received in step 2b with a threshold value and determines whether a reselection processing is needed. If the level of the signal received in step 2b is lower than the threshold value and the reselection is needed, the operation proceeds to step 2d. If the reselection is not needed, the operation proceeds to step 2e.

In step 2d, the control unit 100a executes the reselection. The operation proceeds to step 2e. Details of the reselection will be described later.

In step 2e, the control unit 100a receives, of the signal transmitted from the serving base station, a paging signal inserted into a slot assigned to the mobile communication terminal. The operation proceeds to step 2f.

In step 2f, the control unit 100a determines whether an incoming call is generated, on the basis of the paging signal received in step 2e. The control unit 100a also determines whether an outgoing call request is made via the input unit 70 by a user and whether a position registration processing (registration) needs to be executed via the serving base station. If a result of either of the determinations is “positive”, the operation proceeds to step 2g. If the results of both the determinations are “negative”, the operation proceeds to step 2h.

In step 2g, the control unit 100a executes any of the communication controls such as the control of notifying the generated incoming call, the outgoing call control and the position registration. The operation proceeds to step 2h. Details of the processing in this step will be described later.

In step 2h, the control unit 100a determines whether the count value of the timer Tr started in step 2a exceeds a threshold value t0. If the count value of the timer Tr exceeds the threshold value t0, the operation proceeds to step 2i. If the count value of the timer Tr does not exceed the threshold value t0, the operation returns to step 2e.

In step 2i, the control unit 100a stops the timer Tr and starts a timer Ts to stop power supply to the radio unit 20 and the signal processing unit 30. The apparatus thereby becomes in the sleep state.

After that, if the timer Ts reaches a threshold value T1, the processing of FIG. 2 is started again. The threshold value T1 is set by the control unit 100a on the basis of the timing at which the paging signal is transmitted from the base station to the apparatus.

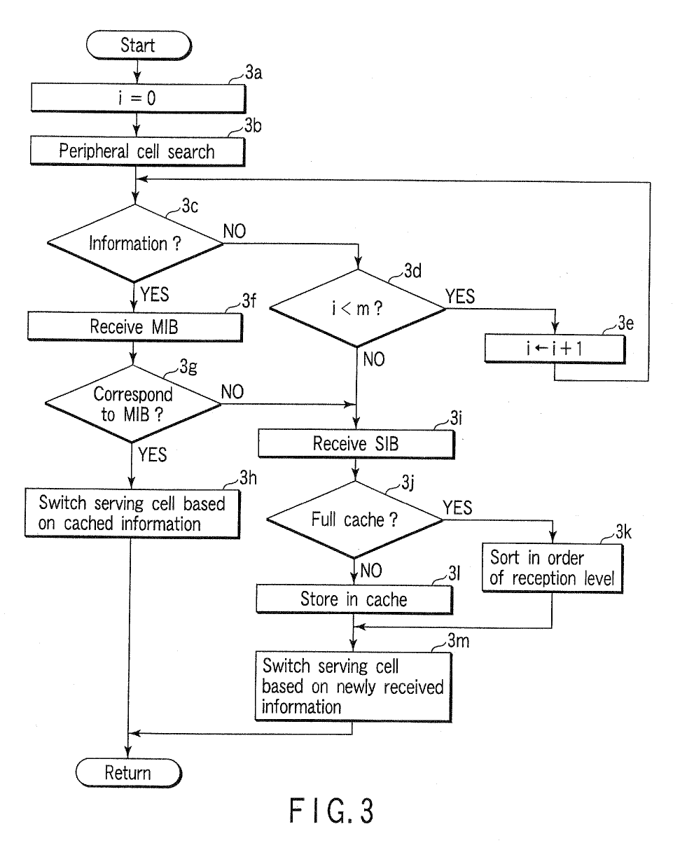

Next, the reselection in step 2d will be explained with reference to FIG. 3. This processing is also executed by the control unit 100a.

In step 3a, the control unit 100a sets “0” at parameter i. The operation proceeds to step 3b.

In step 3b, the control unit 100a executes peripheral cell search. The peripheral cell search is to receive signals transmitted from base stations in cells near the serving cell, detect the cell from which the signals can be received preferably, detect identification information of the cell and detect the power level and the quality level of the received signals. The operation proceeds to step 3c.

In step 3c, the control unit 100a determines whether the identification information detected in step 3b corresponds to i-th information item stored in the cache area of the memory unit 90. If the identification information corresponds to the i-th information item, the operation proceeds to step 3f. If the identification information does not correspond to the i-th information item, the operation proceeds to step 3d.

In step 3d, the control unit 100a determines whether number i is smaller than number m. If number i is smaller than number m, the operation proceeds to step 3e. If number i is equal to or greater than number m, the operation proceeds to step 3i.

In step 3e, the control unit 100a adds “1” to number i. The operation returns to step 3c.

In step 3f, the control unit 100a controls the signal processing unit 30 and receives MIB. The operation returns to step 3g. MIB indicates one of information items included in the BCCH. The BCCH is composed of MIB and SIB.

In step 3g, the control unit 100a determines whether the MIB received in step 3f corresponds to the MIB included in the i-th information item stored in the cache area of the memory unit 90. If both of MIB correspond to each other, the operation returns to step 3h. If they do not correspond to each other, the operation returns to step 3i. The correspondence of MIB is determined by comparing tags added to them.

In step 3h, the control unit 100a switches the cell to be handed as the serving cell to the cell corresponding to the i-th information item stored in the cache area of the memory unit 90 and ends the processing. The operation returns to step 2e.

In step 3i, the control unit 100a controls the signal processing unit 30 to receive the SIB. The operation proceeds to step 3j.

In step 3j, the control unit 100a determines whether the cache area of the memory unit 90 is full. If the cache area is full, the operation proceeds to step 3k. If the cache area includes free space, the operation proceeds to step 3l.

In step 3k, the control unit 100a detects higher-order number m of information of the reception level, on the basis of the reception level detected in step 3b and the reception level corresponding to the information which has already been stored in the cache area of the memory unit 90. The control unit 100a also stores the detected information in the cache area of the memory unit 90. Then the operation proceeds to step 3m. If the reception level detected in step 3b is included in higher-order number m of information, the identification information of the cell detected in step 3b, and the power level and quality level of the received signal are made to correspond to the reception level and stored in the cache.

In step 31, the control unit 100a makes the identification information of the cell detected in step 3b, and the power level and quality level of the received signal correspond to the reception level and stores them in the cache. The operation proceeds to step 3m.

In step 3m, the control unit 100a switches the cell to be handled as the serving cell to the cell detected in step 3b and ends the processing. The operation returns to step 2e.

Next, the communication control of step 2g will be explained with reference to FIG. 4. This processing is executed by the control unit 100a.

In step 4a, the control unit 100a controls the signal processing unit 30 to receive BCCH, i.e. MIB and SIB. The operation proceeds to step 4b.

In step 4b, the control unit 100a controls the radio unit 20 and the signal processing unit 30 to transmit RACH of the power level based on the SIB received in step 4a. The operation proceeds to step 4c. RACH includes the information about the mobile communication terminal which is indispensable for the communication to be made in step 4c.

In step 4c, the control unit 100a executes any of communication controls such as control of notifying a generated incoming call, control of an outgoing call, and the position registration processing. The operation proceeds to step 2h.

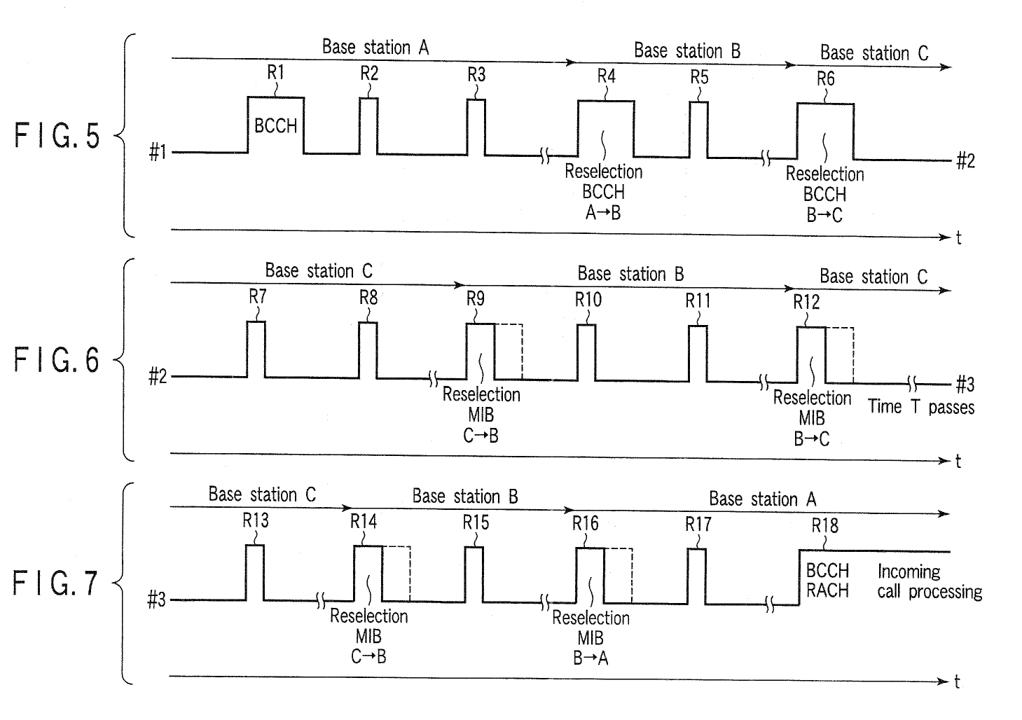

Next, the intermittent reception of the control unit 100a in a case where the mobile communication terminal moves across radio zones of base stations A, B and C which belong to different cells, will be explained. The control unit 100a moves through the radio zones of the base stations in order of base stations A, B, C, B, C, B, and A. An incoming call is generated in the radio zone of the base station A. FIGS. 5 to 7 show the intermittent reception operations of the radio unit 20 and the signal processing unit 30 in this case.

First, the mobile communication terminal, in the radio zone of base station A, detects base station A as the serving base station and receives BCCH from base station A as represented by R1 of FIG. 5. As the BCCH received from base station A is not stored in the cache area of the memory unit 90, the BCCH is stored therein (R1). After that, the intermittent reception is executed while base station A having preferable reception quality serves as the serving base station, as represented by R2 and R3.

The terminal moves from the radio zone of base station A to the radio zone of base station B. As the signal level received from base station A is lowered, the reselection is executed as represented by R4. On the basis of the reselection, the terminal receives the BCCH from base station B and switches base station A to base station B as the serving base station.

As the BCCH received from base station B is not stored in the cache area of the memory unit 90, the BCCH is stored therein. After that, the intermittent reception is executed while base station B having preferable reception quality serves as the serving base station, as represented by R5.

The terminal moves from the radio zone of base station B to the radio zone of base station C. As the signal level received from base station B is lowered, the reselection is executed as represented by R6. On the basis of the reselection, the terminal receives the BCCH from base station C and switches base station B to base station C as the serving base station.

As the BCCH received from base station C is not stored in the cache area of the memory unit 90, the BCCH is stored therein. After that, the intermittent reception is executed while base station C having preferable reception quality serves as the serving base station, as represented by R7 and R8.

After that, the terminal moves again from the radio zone of base station C to the radio zone of base station B. As the signal level received from base station C is lowered, the reselection is executed as represented by R9. On the basis of the reselection, the terminal receives the MIB only from base station B as the BCCH of base station B has been stored in the cache area of the memory unit 90.

If the terminal confirms that the MIB received from base station B is not different from the MIB stored in the cache, the terminal switches base station C to base station B as the serving base station without receiving the SIB. After that, the terminal executes the intermittent reception while base station B having preferable reception quality serves as the serving base station, as represented by R10 and R11.

The terminal moves again from the radio zone of base station B to the radio zone of base station C. As the signal level received from base station B is lowered, the reselection is executed as represented by R12. On the basis of the reselection, the terminal receives the MIB only from base station C as the BCCH of base station C has been stored in the cache area of the memory unit 90.

If the terminal confirms that the MIB received from base station C is not different from the MIB stored in the cache, the terminal switches base station B to base station C as the serving base station without receiving the SIB. After that, the terminal executes the intermittent reception while base station C having preferable reception quality serves as the serving base station, as represented by R13.

After passing time T in the radio zone of base station C, the terminal moves from the radio zone of base station C to the radio zone of base station B. As the signal level received from base station C is lowered, the reselection is executed as represented by R14. On the basis of the reselection, the terminal receives the MIB only from base station B as the BCCH of base station B has been stored in the cache area of the memory unit 90.

If the terminal confirms that the MIB received from base station B is not different from the MIB stored in the cache, the terminal switches base station C to base station B as the serving base station without receiving the SIB. After that, the terminal executes the intermittent reception while base station B having preferable reception quality serves as the serving base station, as represented by R15.

The terminal moves again from the radio zone of base station B to the radio zone of base station A. As the signal level received from base station B is lowered, the reselection is executed as represented by R16. On the basis of the reselection, the terminal receives the MIB only from base station B as the BCCH of base station A has been stored in the cache area of the memory unit 90 though much time has passed.

If the terminal confirms that the MIB received from base station A is not different from the MIB stored in the cache, the terminal switches base station B to base station A as the serving base station without receiving the SIB. After that, the terminal executes the intermittent reception while base station B having preferable reception quality serves as the serving base station, as represented by R17.

After that, if the terminal receives notification of the incoming call from the paging signal received from base station A, the terminal receives the BCCH from base station A, as represented by R18. In addition, the terminal transmits the RACH at the power level based on the BCCH and executes the incoming call processing.

In the reselection, as described above, the terminal having the above-described structure determines whether the BCCH stored in the cache area is new information or old information on the basis of the received MIB. If the MIB is the latest information, the terminal switches the serving base station on the basis of the BCCH stored in the cache area as represented by R9 and R12 in FIG. 6.

Even if a certain time has passed since storing the BCCH in the cache area, the terminal executes the reselection. The terminal determines whether the BCCH stored in the cache area is new information or old information on the basis of the received MIB. If the MIB is the latest information, the terminal switches the serving base station on the basis of the BCCH stored in the cache area as represented by R14 and R16 in FIG. 7.

In addition, the terminal receives the BCCH from the serving base station and executes any of communication controls such as control of notifying the generated incoming call, the outgoing call control and position registration, on the basis of the BCCH, as represented by R18 of FIG. 7.

Thus, in the terminal having the above-described structure, the serving base station is switched on the basis of the BCCH stored in the cache area unless the MIB received from the serving base station is changed. For this reason, the BCCH does not need to be frequently received in the reselection and the consumption of the battery power can be thereby reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

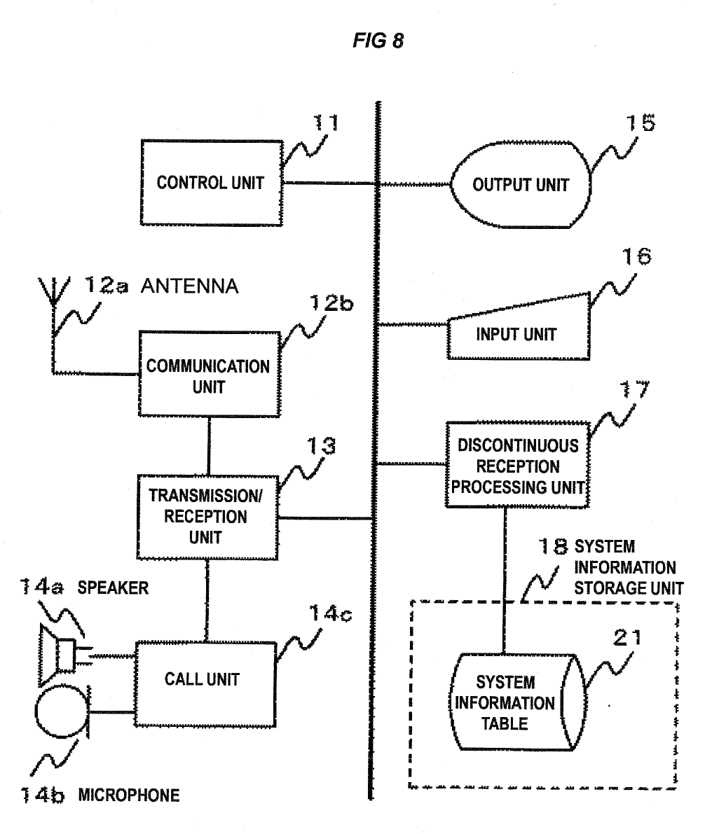

A mobile communication terminal apparatus according to an embodiment of the present invention will be described below with reference to the drawings, as will be a discontinuous receiving method of the mobile communication terminal apparatus. FIG. 8 is a block diagram showing a configuration of the mobile communication terminal apparatus (mobile cell). The apparatus includes a control unit 11 for controlling the whole of the apparatus, an antenna 12a for transmitting/receiving a wave to/from a serving cell (not shown), a communication unit 12b, a transmission/reception unit 13, a speaker 14a, a microphone 14b, a call unit 14c, an output unit 15, an input unit 16, a discontinuous reception processing unit 17, a system information storage unit 18, and a rechargeable battery (not shown) for supplying power to these units. The system information storage unit 18 stores a system information table 21.

The operation of each of the units of the mobile communication terminal apparatus with the above configuration will be described with reference to FIG. 8.

The communication unit 12b transmits a radio-frequency signal from the antenna 12a to the transmission/reception unit 13, and vice versa.

The transmission/reception unit 13 amplifies the radio frequency signal transmitted from the communication unit 12b and converts the frequency of the amplified signal. Then, the unit 13 demodulates the signal into a digital speech signal and sends the digital speech signal to the call unit 14c. The unit 13 also sends a control signal to the control unit 11. Furthermore, the unit 13 modulates the digital speech signal output from the call unit 14c and the control signal output from the control unit 11, and converts the frequencies of these modulated signals. Then, the unit 13 amplifies the signals to generate radio frequency signals, and sends them to the communication unit 12b.

The call unit 14c converts the digital speech signal output from the transmission/reception unit 13 into an analog speech signal, amplifies the signal, and sends the amplified signal to the speaker 14a. The call unit 14c also amplifies the analog speech signal output from the microphone 14b, converts the amplified signal into a digital speech signal, and sends the digital speech signal to the transmission/reception unit 13.

The output unit 15 is a display device such as an LCD. The output unit 15 is started by the control unit 11 to perform its display operation. The output unit 15 continues to display the same contents until it is started by the control unit 11 in response to an input operation of the input unit 16.

The input unit 16 includes a plurality of keys. As the control unit 11 starts, the input unit 16 starts to operate. In response to a key input by a user, the input unit 16 notifies the control unit 11 of a code for identifying the key, thus completing its operation.

The operation of the discontinuous reception processing unit 17 will now be described. The unit 17 manages system information of an idle serving cell and detects the presence or absence of an incoming call. The unit 17 also determines whether to reselect a cell.

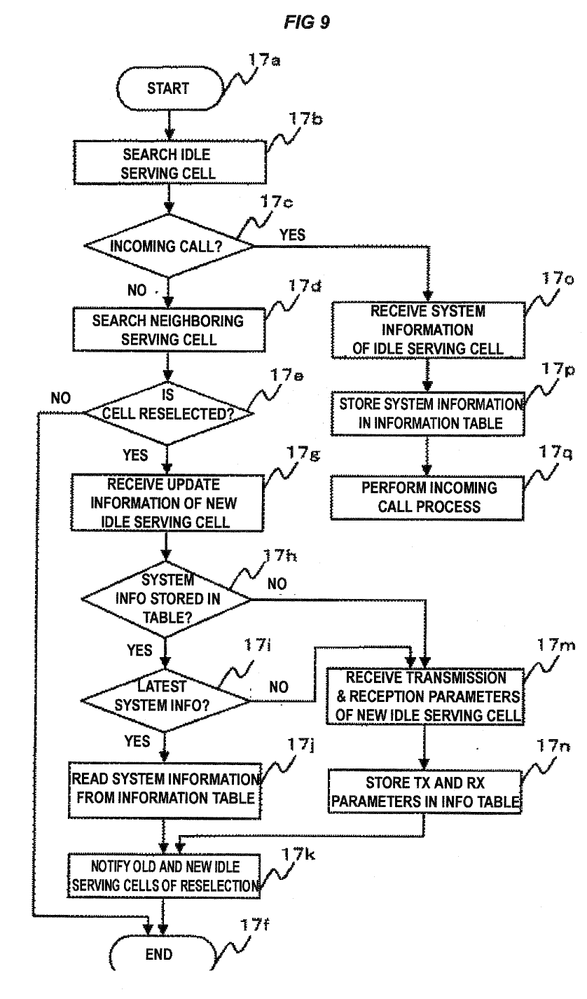

FIG. 9 is a flowchart of the operation of the discontinuous reception processing unit 17. The unit 17 is started by the control unit 11 at every discontinuous reception cycle to perform its operation (step 17a). First, the unit 17 receives a common pilot signal from the idle serving cell through a common pilot channel and searches the idle serving cell (step 17b). At the same time, the unit 17 measures the quality of the wave of the common pilot signal that is transmitted through the common pilot channel. The quality of the wave is good as the intensity of the wave and as the signal-to-noise ratio of the wave.

The discontinuous reception processing unit 17 detects the presence or absence of a call coming to the unit 17 and causes its operation to branch according to the result of the detection (step 17c). In other words, the unit 17 receives a paging indicator signal through a paging indicator channel, and determines that no call is coming to the unit 17 if the signal indicates the absence of an incoming call.

If the paging indicator signal indicates the presence of an incoming call, the discontinuous reception processing unit 17 receives paging information through the paging channel and analyzes the information to determine the presence or absence of a call coming to the unit 17.

If there is no call coming to the unit 17 (No in step 17c), the discontinuous reception processing unit 17 receives a common pilot signal from a serving cell neighboring to the idle serving cell through the common pilot channel, and searches the neighboring serving cell (step 17d). At the same time, the unit 17 measures the quality of the wave of the common pilot signal that is transmitted from the neighboring serving cell through the common pilot channel.

After that, the discontinuous reception processing unit 17 determines whether to reselect a cell (step 17e). In other words, the unit 17 determines that a cell is not reselected at once if the quality of the wave of the common pilot signal, which is measured in step 17b, is not less than a given threshold value.

If the quality of the wave of the common pilot signal is less than the given threshold value and the unit 17 receives a wave whose quality is higher than the quality of the above wave from the neighboring serving cell, the unit 17 determines that a cell is reselected setting the serving cell, which transmits the wave of higher quality, as a new idle serving cell. In the other cases, the unit 17 determines that a cell is not reselected.

If the discontinuous reception processing unit 17 determines that a cell is not reselected (NO in step 17e), it completes its discontinuous reception processing (step 17f).

On the other hand, if the discontinuous reception processing unit 17 determines that a cell is reselected (YES in step 17e), it receives the update number of system information of a new idle serving cell, which is selected in step 17e, from the new idle serving cell through a broadcast common control channel (step 17g). After that, the unit 17 determines whether the system information of the new idle serving cell is stored in the system information table 21, using an identifier of the new idle serving cell (step 17h).

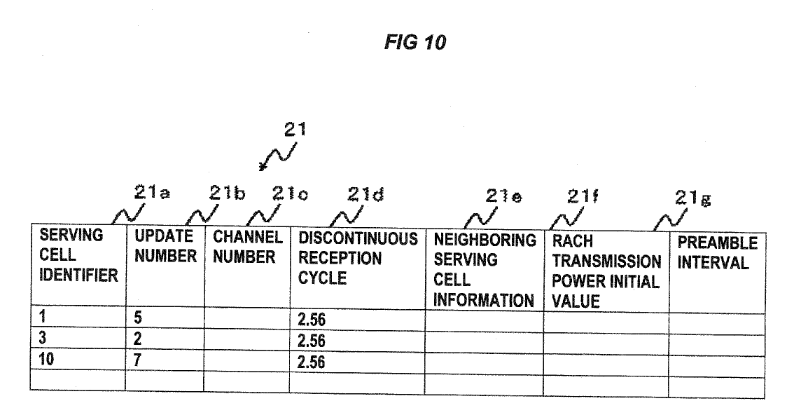

FIG. 10 shows an example of the system information table 21. The system information table 21 includes data of a serving cell identifier 21a, an update number 21b, a channel number 21c, a discontinuous reception cycle 21d, neighboring serving cell information 21e, an RACH transmission power initial value 21f, and a preamble interval 21g. The system information table 21 can include other data.

The serving cell identifier 21a is information for identifying a serving cell uniquely and a scrambling code of the serving cell. The update number 21b, channel number 21c, discontinuous reception cycle 21d, neighboring serving cell information 21e, RACH transmission power initial value 21f, and preamble interval 21g are system information of the serving cell that is identified by the serving cell identifier 21a.

More specifically, the update number 21b is information that indicates the update statuses of the channel number 21c, discontinuous reception cycle 21d and neighboring serving cell information 21e. The channel number 21c is a channel number of a control channel used by a serving cell that is identified by the serving cell identifier 21a. The discontinuous reception cycle 21d is a time interval during which information about the presence or absence of an incoming call is transmitted from the serving cell that is identified by the serving cell identifier 21a.

The neighboring serving cell information 21e is information of a serving cell neighboring to the serving cell identified by the serving cell identifier 21a. Specifically, the information 21e includes a channel number of the pilot channel common to the neighboring serving cells.

The channel number 21c, discontinuous reception cycle 21d, and neighboring serving cell information 21e are reception parameters necessary for performing a discontinuous receiving operation setting the serving cell identified by the serving cell identifier 21a as an idle serving cell.

The RACH transmission power initial value 21f is the initial value of power for transmitting a given preamble from a mobile communication terminal apparatus when call communication is started. The preamble interval 21g is a time interval during which the preamble is transmitted.

The RACH transmission power initial value 21f and preamble interval 21g are transmission parameters necessary for an RACH transmission process that is performed when call communication with the serving cell identified by the serving cell identifier 21a is started.

The transmission parameters, which depend upon the number of mobile cells with which a serving cell communicates and the power of transmission used for the communication, are determined by the serving cell. The RACH transmission power initial value 21f and preamble interval 21g transmitted by the serving cell are therefore updated at all times.

In step 17h, the discontinuous reception processing unit 17 searches the serving cell identifier 21a of the system information table 21 for data that is equal to the identifier of the new idle serving cell described above. When the unit 17 searches for the data (YES in step 17h), it compares the update number 21b of the searched data with the update number of system information of the new idle serving cell received in step 17g (step S17i).

If the above two update numbers are equal to each other, the discontinuous reception processing unit 17 determines that the system information of the new idle serving cell stored in the system information table 21 is the latest (LATEST in step 17i). Then, the unit 17 reads the system information of the new idle serving cell from the system information table 21 (step 17j) and stores it in a given storage area (not shown) of the control unit 11.

The discontinuous reception processing unit 17 notifies the idle serving cell prior to the reselection of a cell and the new idle serving cell of the reselection of a cell (step 17k), and completes its discontinuous reception processing (step 17f).

If the system information of the new idle serving cell is not stored in the system information table 21 (NO in step 17h), and the two update numbers are not equal to each other, or the system information of the new idle serving cell stored in the system information table 21 is not the latest (NOT LATEST in step 17i), the discontinuous reception processing unit 17 receives reception and transmission parameters of the system information from the new idle serving cell through the broadcast common control channel (step 17m).

The discontinuous reception processing unit 17 stores the received reception and transmission parameters, or the channel number 21c, discontinuous reception cycle 21d, neighboring serving cell information 21e, RACH transmission power initial value 21f, preamble interval 21g, and the update number 21b received in step 17g as well as the serving cell identifier 21a of the new idle serving cell in the system information table 21 (step 17n).

The discontinuous reception processing unit 17 stores the system information of the system information table 21 in a given storage area of the control unit 11 as system information of the idle serving cell. The unit 17 notifies the old and new idle serving cells of the reselection of a cell (step 17k) and completes its processing (step 17f).

If the discontinuous reception processing unit 17 detects the presence of an incoming call (YES in step 17c), it receives the system information of a serving cell through the broadcast common control channel (step 17o) and stores it in the system information table 21 (step 17p). Furthermore, the unit 17 stores the system information in a given storage area of the control unit 11 as the system information of the idle serving cell, and transfers its operation to an incoming call processing unit (not shown) (step 17q).

The system information of the idle serving cell, which is stored in a given storage area of the control unit 11, is used when the incoming call processing unit makes an RACH transmission. In other words, the incoming call processing unit can make an RACH transmission by adequate transmission power, using the latest RACH transmission power initial value 21f and preamble interval 21g.

The RACH transmission is made by an outgoing call processing unit (not shown) as well as the incoming call processing unit. The outgoing call processing unit performs a process of receiving the system information of the idle serving cell in step 17o and a process of storing the received system information in step 17p prior to its outgoing call processing.

Furthermore, the system information includes an identifier for a location registration area (general incoming call area) to which the serving cell belongs. Though not shown, the identifier is stored in the system information table 21.

When an identifier for a location registration area of an idle serving cell prior to the reselection of a cell and an identifier for a location registration area of a new idle serving cell are different from each other, the discontinuous reception processing unit 17 not only notifies these serving cells of the reselection of a cell but also communicates with the new idle serving cell for the location registration in step 17k.

Since the RACH transmission is used for communication for the location registration, the discontinuous reception processing unit 17 performs a process of receiving the system information of the idle serving cell in step 17o and a process of storing the received system information in step 17p before its RACH transmission and during the execution of step 17k after step 17j but not through step 17m or step 17n.

When the system information table 21 has no storage capacity enough to store the system information of the new idle serving cell in step 17n, the system information of another serving cell is deleted to increase the storage capacity.

The discontinuous reception processing unit 17 stores the quality of the wave of a common pilot signal, which is transmitted through a common pilot channel from each serving cell, in the system information table 21, and updates the stored quality when it makes the search for an idle serving cell in step 17b and the search for a serving cell neighboring to the idle serving cell in step 17d. In order to increase the storage capacity, the system information of a serving cell in which the lowest quality is stored is deleted. The present invention is not limited to the above configuration, but various modifications can be made.

As has been described above, according to the present invention, the system information of an old idle serving cell is stored and used. Thus, the amount of system information received from a new idle serving cell can be prevented from increasing and the idle serving cell can be prevented from being lost. Moreover, the power consumption of the mobile communication terminal apparatus in idle mode can be reduced.

What is claimed is:

1. A mobile radio terminal apparatus comprising:
communicating means for communicating with a base station which reports system information unique to the base station, as required;
storing means for coordinately storing the system information, tag information added to part of the system information, and identification information of the base station, which are received by the communicating means;
receipt control means for comparing the tag information stored in the storing means with tag information of system information newly received by the communicating means, and for: (i) causing the storing means to store only a part of the newly received system information but not the other part of the newly received system information if the tag information stored in the storing means and the tag information of the newly received system information are equivalent, and (ii) causing the communicating means to newly receive the system information and causing the storing means to store the newly received system information if the tag information stored in the storing means and the tag information of the newly received system information are not equivalent; and
communication processing means for, at the time of transmitting an RACH signal, causing the communicating means to newly receive the system information and transmit the RACH signal in accordance with the newly received system information regardless of whether or not the tag information stored in the storing means and the tag information of the newly received system information are equivalent.

2. The mobile radio terminal apparatus according to claim 1, wherein the system information is BCCH information including an MIB and an SIB.

3. The mobile radio terminal apparatus according to claim 2, wherein the tag information is added to the MIB.

4. The mobile radio terminal apparatus according to claim 1, wherein if an incoming call is detected from a paging signal transmitted from the base station, the communication processing means causes the communicating means to newly receive the system information from the base station and transmit the RACH signal at a power level in accordance with the newly received system information, thereby performing incoming call processing.

5. The mobile radio terminal apparatus according to claim 1, further comprising inputting means for accepting an outgoing call request from a user,
wherein if the inputting means accepts the outgoing call request, the communication processing means causes the communicating means to newly receive the system information.

6. The mobile radio terminal apparatus according to claim 1, further comprising position registration processing means for performing position registration,
wherein if the position registration processing means performs the position registration, the communication processing means causes the communicating means to newly receive the system information.

7. The mobile radio terminal apparatus according to claim 1, further comprising reselection means for reselecting a peripheral base station as the base station,
wherein if the reselection means makes a reselection, the receipt control means causes the communicating means to newly receive the system information from the peripheral base station.

8. The mobile radio terminal apparatus according to claim 7, further comprising quality detection means for comparing a level of a signal received from the base station with a level of a signal received from the peripheral base station,
wherein if the quality detection means newly detects a peripheral base station from which a signal of good quality is received, the reselection means makes the reselection.

9. The mobile radio terminal apparatus according to claim 8, wherein an SIB is included in the system information that is newly received when the tag information stored in the storing means and the tag information of the newly received system information are compared and found to be not equivalent by the receipt control means.

10. The mobile radio terminal apparatus according to claim 9, wherein the SIB is included in the other part of the newly received system information that is not stored when the tag information stored in the storing means and the tag information of the newly received system information are compared and found to be equivalent by the receipt control means.

11. A mobile radio communication method comprising:
communicating with a base station which reports system
information unique to the base station, as required;
coordinately storing the received system information, tag information added to the part of the system information, and identification information of the base station;
comparing the stored tag information with tag information of newly received system information and: (i) causing only part of the newly received system information but not the other part of the newly received system information to be stored if the stored tag information and the tag information of the newly received system information are equivalent, and (ii) newly receiving the system information to be stored if the stored tag information and the tag information of the newly received system information are not equivalent; and
performing communication processing at a time of transmitting an RACH signal, to newly receive the system information and transmit the RACH signal in accordance with the newly received system information regardless of whether or not the stored tag information and the tag information of the newly received system information are equivalent.

12. The mobile radio communication method according to claim 11, wherein the system information is BCCH information including an MIB and an SIB.

13. The mobile radio communication method according to claim 12, wherein the tag information is added to the MIB.

14. The mobile radio communication method according to claim 11, wherein if an incoming call is detected from a paging signal transmitted from the base station, communication processing includes is performed to newly receive the system information from the base station and transmit the RACH signal at a power level in accordance with the newly received system information, thereby performing incoming call processing.

15. The mobile radio communication method according to claim 11, further comprising accepting an outgoing call request from a user,
wherein when the outgoing call request is accepted, the communication processing is performed to newly receive the system information.

16. The mobile radio communication method according to claim 11, further comprising position registration processing to perform position registration,
wherein when the position registration processing is performed, the communication processing is performed to newly receive the system information.

17. The mobile radio communication method according to claim 11, further comprising performing reselection to reselect a peripheral base station as the base station,
wherein if the reselection occurs, the system information is newly received and said comparing is performed.

18. The mobile radio communication method according to claim 17, further comprising performing quality detection to compare a level of a signal received from the base station with a level of a signal received from the peripheral base station,
wherein if the quality detection newly detects a peripheral base station from which a signal of good quality is received, the reselection occurs.

19. The mobile radio communication method according to claim 18, wherein an SIB is included in the system information that is newly received when the stored tag information and the tag information of the newly received system information are compared and found to be not equivalent.

20. The mobile radio communication method according to claim 19, wherein the SIB is included in the other part of the newly received system information that is not stored when the stored tag information stored and the tag information of the newly received system information are compared and found to be equivalent.

21. A communication method of a mobile communication terminal apparatus connected to a base station which transmits system information including transmit/receive parameters unique to the base station and update information of a receive parameter contained in the transmit/receive parameters, wherein the apparatus receives and stores the system information from the base station if the base station is selected as a standby base station and the update information received therefrom is not equivalent to update information of the standby base station stored in the apparatus, said method comprises:
receiving a signal transmitted from the standby base station in accordance with the receive parameter included in the stored system information;
if an incoming call signal is detected from the received signal, receiving the system information from the standby base station regardless of whether or not the update information of the stored system information and the update information transmitted from the standby base station are equivalent; and
making an incoming call report in accordance with a transmit parameter included in the received system information.

22. A communication method of a mobile communication terminal apparatus connected to a base station which transmits system information including transmit/receive parameters unique to the base station, update information of a receive parameter contained in the transmit/receive parameters, and identification information of a position registration area of the base station, wherein the apparatus receives and stores the system information from the base station if the base station is selected as a standby base station and the update information received therefrom is not equivalent to the update information of the standby base station stored in the apparatus, said comprising:
receiving signals transmitted from the standby base station and a base station adjacent to the standby base station in accordance with the receive parameter included in the stored system information;
measuring qualities of the received signals;
if the quality of the signal received from the adjacent base station is higher than the of the signal received from the standby base station with reference to a measurement result, selecting the adjacent base station as a new standby base station;
if system information from the selected new standby base station is stored in advance and a position registration area included in such system information differs from the position registration area included in the system information received from the standby base station prior to the selection of the new standby base station, receiving the system information from the new standby base station regardless of whether or not the update information of the system information of the new standby base station stored in advance and the update information transmitted from the new standby base station are equivalent; and
performing position registration by communicating with the new standby base station in accordance with a transmit parameter included in the received system information.

23. A communication method of a mobile communication terminal apparatus connected to a base station which transmits system information including transmit/receive parameters unique to the base station and update information of a receive parameter contained in the transmit/receive parameters, wherein the apparatus receives and stores the system information from the base station if the base station is selected as a standby base station and the update information received therefrom is not equivalent to update information of the standby base station stored in the apparatus, and wherein the apparatus intermittently receives a signal transmitted from the standby base station in accordance with the receive parameter included in the system information, said method comprising:
if an instruction from a user to make an outgoing call is accepted, receiving the system information from the standby base station regardless of whether or not the update information is included in the stored system information and the update information transmitted from the base station are equivalent; and
performing outgoing call control in accordance with a transmit parameter included in the received system information.
